(19) United States
(12) Patent Application Publication
(10) Pub. No.: US 2024/0202737 A1
(43) Pub. Date: Jun. 20, 2024

(54) METHOD AND SYSTEM FOR IMPROVING CUSTOMER EXPERIENCE WITH A TECHNICAL SUPPORT ENTITY

(71) Applicant: Dell Products L.P., Round Rock, TX (US)

(72) Inventors: Parminder Singh Sethi, Ludhiana (IN); Lakshmi Saroja Nalam, Bangalore (IN)

(21) Appl. No.: 18/066,757

(22) Filed: Dec. 15, 2022

(51) Int. Cl. G06Q 30/015; H04L 41/50; H04L 41/5061

(52) U.S. Cl. CPC G06Q 30/015; H04L 41/5032; H04L 41/5064

(57) ABSTRACT

A method for managing a technical support (TS) conversation includes: determining an initial state of a user based on TS history of the user; classifying a first sentence of a TS entity into a first category and a second sentence of the user into a second category; obtaining, based on the first category and the second category, a mapping between the first sentence and the second sentence; obtaining a TS conversation score based on the initial state and the second category; generating a TS recommendation based on the TS history, the mapping, and the TS conversation score; and initiating display of the TS recommendation on a graphical user interface (GUI) accessible to the TS entity.

### BACKGROUND

Once computing devices are deployed, users (e.g., customers, legal entities, etc.) of these computing devices often encounter failures relate to the operation of these computing devices. In most cases, customers try to resolve these failures internally, but when they could not resolve these failures, they contact technical support (TS) entities to assist them in solving the failures with their computing devices.

### BRIEF DESCRIPTION OF DRAWINGS

Certain embodiments of the invention will be described with reference to the accompanying drawings. However, the accompanying drawings illustrate only certain aspects or implementations of the invention by way of example, and are not meant to limit the scope of the claims.

FIG. 1 shows a diagram of a system in accordance with one or more embodiments of the invention.

FIG. 2 shows a diagram of a technical support system (TSS) in accordance with one or more embodiments of the invention.

FIGS. 3.1 and 3.2 show a method for improving customer experience with a TS entity in accordance with one or more embodiments of the invention.

FIGS. 4.1 and 4.2 show an exemplary visual stream in accordance with one or more embodiments of the invention.

FIG. 5 shows a diagram of a computing device in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of one or more embodiments of the invention. However, it will be apparent to one of ordinary skill in the art that the one or more embodiments of the invention may be practiced without these specific details. In other instances, well-known features have not been described in detail to avoid unnecessarily complicating the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, customers (e.g., employees of an organization, external customers, etc.) reach out to a TS entity (e.g., a technical support specialist, a technical support personnel (TSP), a TSS, etc.) (i) to know about a particular service, (ii) to resolve (e.g., to address) a technical support issue (TSI) (e.g., a hardware issue, a software issue, a licensing issue, etc.), and/or (iii) to receive technical support (e.g., assistance). In order to reach out to a TS entity, customers may use chat support, voice support, and/or virtual assistance tools/channels.

Most of the customers reach out to TS entities when, for example, an issue starts to impact their production workloads (e.g., reading data from assets, writing data to the assets, etc.). Typically, when customers reach out to a TS entity, (i) they are in a hurry to get the issue resolved so that they can continue their operations/activities and (ii) they repeat “issue related” inquiries until the issue is resolved; however, repeated inquiries (and associated TS responses to those inquiries) make an ongoing TS conversation (e.g., an ongoing TS session) lengthy.

In most cases, when a customer reaches out to a TS entity because of an issue occurred in the customer's computing device, the TS entity may not be aware of how the customer is affected by the issue. Typically, as a result of not being aware of how the customer is affected by the issue, the TS entity may address the issue similar to (e.g., in a same pace and manner) other customers' issues. Because of that, the customer may leave the ongoing TS conversation with a bad experience and may not reach out to the TS entity again.

Embodiments of the invention relate to methods and systems to improve customer experience with a TS entity during an ongoing TS conversation. More specifically, the embodiments of the invention provide a proactive and runtime approach to analyze an ongoing TS conversation to manage a customer's experience with a TS entity. First, based on a TS history of a customer, an initial state of the customer may be determined. A first sentence of a TS entity may be classified into a first category and a second sentence of the customer may be classified into a second category. Based on the first and second categories, a mapping between the first and second sentences may then be obtained. Thereafter, based on the initial state and the second category, a TS conversation score may be obtained. A TS recommendation may then be generated based on the TS history, mapping, and TS conversation score. Finally, displaying of the TS recommendation may be initiated on a graphical user interface (GUI) accessible to the TS entity. As a result of the processes discussed below, one or more embodiments disclosed herein advantageously ensure that the TS entity is aware of the customer's condition regarding the issue. In this manner, the ongoing TS conversation may be analyzed better in order to improve the customer's experience with the TS entity.

The following describes various embodiments of the invention.

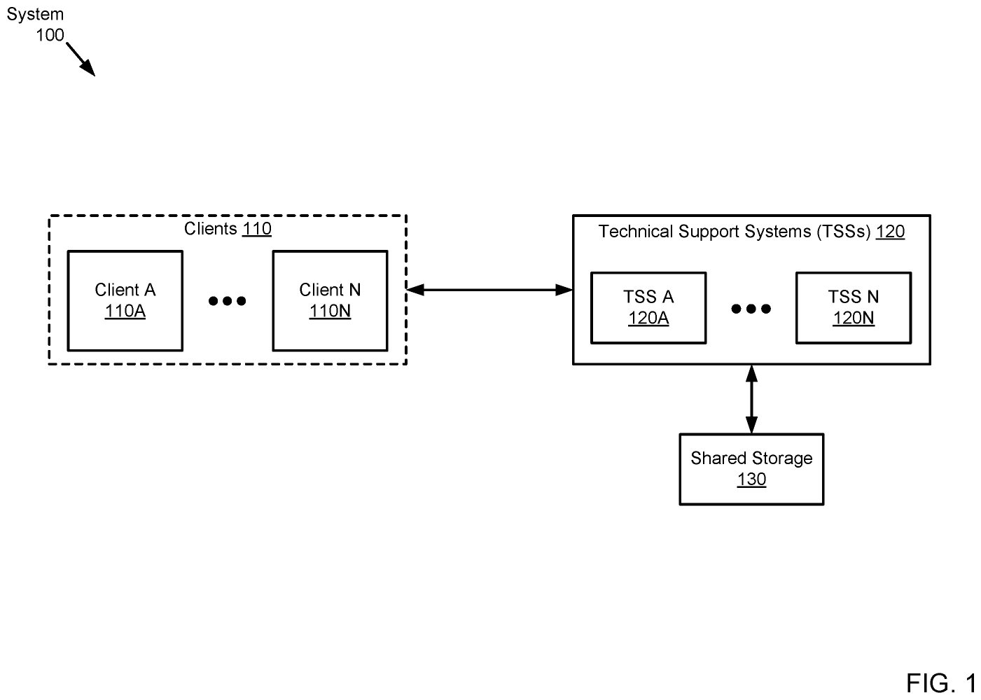

FIG. 1 shows a diagram of a system (100) in accordance with one or more embodiments of the invention. The system (100) includes any number of clients (110), any number of TSSs (120), and a shared storage (130). The system (100) may include additional, fewer, and/or different components without departing from the scope of the invention. Each component may be operably connected to any of the other components via any combination of wired and/or wireless connections. Each component illustrated in FIG. 1 is discussed below.

While FIG. 1 shows a specific configuration of the system (100), other configurations may be used without departing from the scope of the invention. For example, although the clients (110) and the TSSs (120) are shown to be directly connected (without an intervening network (not shown)), the clients (110) and the TSSs (120) may be operatively connected through a network. As yet another example, although the TSSs (120) and the shared storage (130) are shown to be directly connected, the TSSs (120) and the shared storage (130) may be executing on the same host.

Further, the functioning of the clients (110) and the TSSs (120) is not dependent upon the functioning and/or existence of the other device(s) in the system (100). Rather, the clients (110) and the TSSs (120) may function independently, and perform operations locally that do not require communication with other devices. Accordingly, embodiments disclosed herein should not be limited to the configuration of devices and/or components shown in FIG. 1.

In one or more embodiments, the system (100) may be a part of a technical support region (TSR) (not shown), in which the TSR corresponds to a geographic region (e.g., a city, a county, a state, a province, a country, a country grouping (e.g., the European Union), etc.). In order to facilitate sharing of information (e.g., data) between TSSs in various TSRs, the TSSs (120) may transmit information to a technical support hub (TSH) (not shown) and the TSH may distribute the information to other TSSs in other TSRs. In this configuration, the TSH may serve as a “hub in a hub-spoke architecture”.

In another architecture, the TSH may maintain information received from the TSSs (120) and then transmits this information to other TSSs. The TSSs (120) may then communicate with other TSSs directly. In this configuration, the TSSs (120) may operate in a point-to-point architecture and rely on the TSH to discover other TSSs.

In one or more embodiments, a customer may need to contact (e.g., reach out to) a TS entity to address a TSI. The TSI may be related to a client (e.g., 110A, 110N, etc.) that the customer is using (e.g., interacting with) or related to another computing device (not shown) (logical or physical) that the customer is using. The TSI may be any issue that prevents (or impairs) the customer's ability to access and/or use, for example (but not limited to): the client, an application executing on the client, etc. The TSI may also be an issue that prevents one or more functionalities of the client (e.g., 110A, 110N, etc.).

In one or more embodiments, a client (e.g., 110A, 110N, etc.) may be a physical computing device or a logical computing device (e.g., a virtual machine (VM)) configured for hosting one or more workloads, or for providing a computing environment (e.g., computing power and storage) whereon workloads may be implemented. Further, a client (e.g., 110A, 110N, etc.) may correspond to a computing device that a customer is using to interact with a TSS (e.g., 120A, 120N, etc.).

In one or more embodiments, a workload (not shown) may refer to a physical or logical component configured to perform certain work functions. Workloads may be instantiated (e.g., initiated, executed, etc.) and may be operated while consuming computing resources (e.g., processing resources, networking resources, etc.) allocated thereto. Examples of a workload may include (but not limited to): a VM, a container, an application, etc.

As used herein, a “container” is an executable unit of software in which an application code is packaged, along with its libraries and dependencies, so that it can be executed anywhere. To do this, a container takes advantage of a form of operating system (OS) virtualization in which features of the OS are leveraged to both isolate processes and control the amount of central processing unit (CPU), memory, and disk that those processes have access to.

Comparing to a VM, a container does not need to include a guest OS in every instance and may simply leverage the features and resources of a host OS. For example, instead of virtualizing the underlying hardware components, a container virtualize the OS, so the container includes only the application (and its libraries and dependencies). The absence of the guest OS makes a container lightweight, fast, and portable.

As used herein, “computing” refers to any operations that may be performed by a computer, including (but not limited to): computation, data storage, data retrieval, communications, etc.

As used herein, a “computing device” refers to any device in which a computing operation may be carried out. A computing device may be, for example (but not limited to): a compute component, a storage component, a network device, a telecommunications component, etc.

In one or more embodiments, a client (e.g., 110A, 110N, etc.) may include any number of applications (and/or content accessible through the applications) that provide application services to a customer. Application services may include, for example (but not limited to): database services, electronic communication services, instant messaging services, file storage services, etc. In order to provide application services, each application may host similar or different components. The components may be, for example (but not limited to): instances of databases, instances of email servers, etc. The applications may be executed on one or more clients as instances of the application.

As used herein, a “database” is an organized collection of unstructured and/or structured data, typically stored in a computing system. In most cases, a database is controlled by a database management system, in which the data and the database management system (along with the applications that are associated with them) are referred to as a “database system”. Data within the database system (simply “database”) is typically modeled in rows and columns in a series of tables to make processing and querying efficient. Most databases use structured query language (SQL) for writing and querying data.

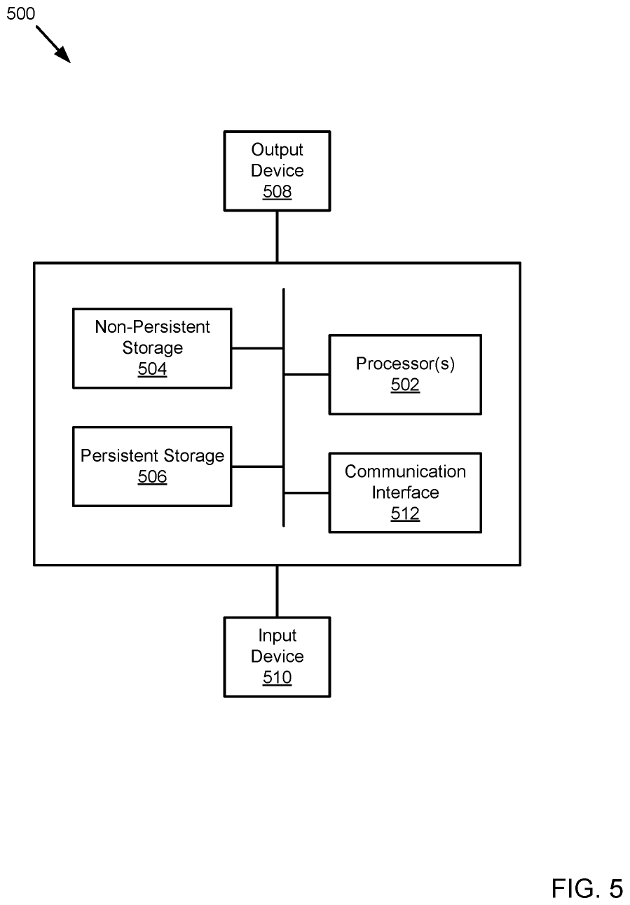

As used herein, a “server” may provide computer-implemented services (e.g., receiving a request, sending a response to the request, etc.) to the customers. In one or more embodiments, the request may be, for example (but not limited to): a web browser search request, a computing request, a database management request, etc. To provide the computer-implemented services to the customers, the server may perform computations locally and/or remotely. By doing so, the server may utilize different computing devices (e.g., 500, FIG. 5) that have different quantities of computing resources (e.g., processing cycles, memory, storage, etc.) to provide a consistent customer experience to the customers.

Further, applications may vary in different embodiments, but in certain embodiments, applications may be custom developed or commercial (e.g., off-the-shelf) applications that a customer desires to execute in a client (e.g., 110A, 110N, etc.). In one or more embodiments, applications may be logical entities executed using computing resources of a client (e.g., 110A, 110N, etc.). For example, applications may be implemented as computer instructions, e.g., computer code, stored on a persistent storage of the client that when executed by a processor(s) of the client cause the client to provide the functionality of the applications described throughout this application.

In one or more embodiments, while performing, for example, one or more operations requested by a customer, applications installed on a client (e.g., 110A, 110N, etc.) may include functionality to request and use resources (e.g., data, computing resources, etc.) of the client. The applications may perform other types of functionalities not listed above without departing from the scope of the invention. In one or more embodiments, while providing application services to a customer, applications may store data that may be relevant to the customer in storage/memory resources (discussed below) of a client (e.g., 110A, 110N, etc.).

In one or more embodiments, the clients (110) may provide computer-implemented services to customers (and/or other computing devices such as, other clients or other types of devices). The clients (110) may provide any number and any type of computer-implemented services (e.g., data storage services, electronic communication services, etc.). To provide computer-implemented services, each client (e.g., 110A, 110N, etc.) may include a collection of physical components (e.g., processing resources, storage/memory resources, networking resources, etc.) configured to perform operations of the client and/or otherwise execute a collection of logical components (e.g., applications, virtualization resources, etc.) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a CPU, a graphical processing unit (GPU), a data processing unit (DPU), etc.

In one or more embodiments, a storage or memory resource (not shown) may refer to a measurable quantity of a storage/memory-relevant resource type, which can be requested, allocated, and consumed. A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

As used herein, “storage” may refer to a hardware component that is used to store data in a client (e.g., 110A, 110N, etc.). Storage may be a physical computer readable medium. In most cases, storage may be configured as a storage array (e.g., a network attached storage array), in which a storage array may refer to a collection of one or more physical storage devices. Each physical storage device may include non-transitory computer readable storage media, in which the data may be stored in whole or in part, and temporarily or permanently.

As used herein, “memory” may be any hardware component that is used to store data in a client (e.g., 110A, 110N, etc.). The data stored may be accessed almost instantly (e.g., in milliseconds) regardless of where the data is stored in memory. The memory may provide the above-mentioned instant data access because the memory may be directly connected to a CPU on a wide and fast bus (e.g., a high-speed internal connection that transfers data among hardware components of the client).

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card, a network adapter, a network processor, etc.

In one or more embodiments, a networking resource may provide capabilities to interface a client (e.g., 110A, 110N, etc.) with external entities (e.g., other clients, the TSSs (120), etc.) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transmission control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the client (e.g., 110A, 110N, etc.) and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing remote direct memory access (RDMA) to access data on another client, it may not be necessary to interact with the logical components of that client. Rather, when using RDMA, it may be possible for the networking resource to interact with the physical components of that client to retrieve and/or transmit data, thereby avoiding any higher-level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU, a virtual storage pool, etc.

As an example, a VM may be executed using computing resources of a client (e.g., 110A, 110N, etc.). The VM (and applications hosted by the VM) may generate data (e.g., VM data) that is stored in the storage/memory resources of the client, in which the VM data may reflect a state of the VM. In one or more embodiments, the VM may provide services to customers, and may host instances of databases, email servers, or other applications that are accessible to the customers.

In one or more embodiments, a virtualization resource may include a hypervisor, in which the hypervisor may be configured to orchestrate an operation of a VM by allocating computing resources of a client (e.g., 110A, 110N, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor.

Alternatively, in one or more of embodiments, the hypervisor may be implemented as computer instructions, e.g., computer code, stored on storage/memory resources of the client that when executed by processing resources of the client cause the client to provide the functionality of the hypervisor.

In one or more embodiments, the clients (110) may be implemented as computing devices (e.g., 500, FIG. 5). A computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the clients (110) described throughout this application.

Alternatively, in one or more embodiments, the clients (110) may be implemented as logical devices. A logical device may utilize the computing resources of any number of computing devices to provide the functionality of the clients described throughout this application.

In one or more embodiments, customers may interact with (or operate) the clients (110) in order to perform work-related tasks (e.g., production workloads). In one or more embodiments, the accessibility of customers to the clients (110) may depend on a regulation set by the administrators (e.g., a user with permission to make changes on a client that will affect other customers of that client). To this end, each customer may have a personalized customer account that may, for example, grant access to certain data, applications, and computing resources of the clients (110). This may be realized by implementing a “virtualization” technology. Virtualization allows for the generation of a VM that behaves as if it were a physical computing device with its own hardware components. When properly implemented, VMs on the same host (e.g., the client) are sandboxed from one another so that they do not interact with each other, and the data, applications, and computing resources from one VM are not visible to another VM even though they are on the same physical host.

In one or more embodiments, for example, a customer may be automatically directed to a login screen of a client (e.g., 110A, 110N, etc.) when the customer connected to that client. Once the login screen of the client is displayed, the customer may enter credentials (e.g., username, password, etc.) of the customer on the login screen. The login screen may be a GUI generated by a visualization module (not shown) of the client. In one or more embodiments, the visualization module may be implemented in hardware (e.g., circuitry), software, or any combination thereof.

In one or more embodiments, the GUI may be displayed on a display of a computing device (e.g., 500, FIG. 5) using functionalities of a display engine (not shown), in which the display engine is operatively connected to the computing device. The display engine may be implemented using hardware, software, or any combination thereof. The login screen may be displayed in any visual format that would allow the customer to easily comprehend (e.g., read and parse) the listed information.

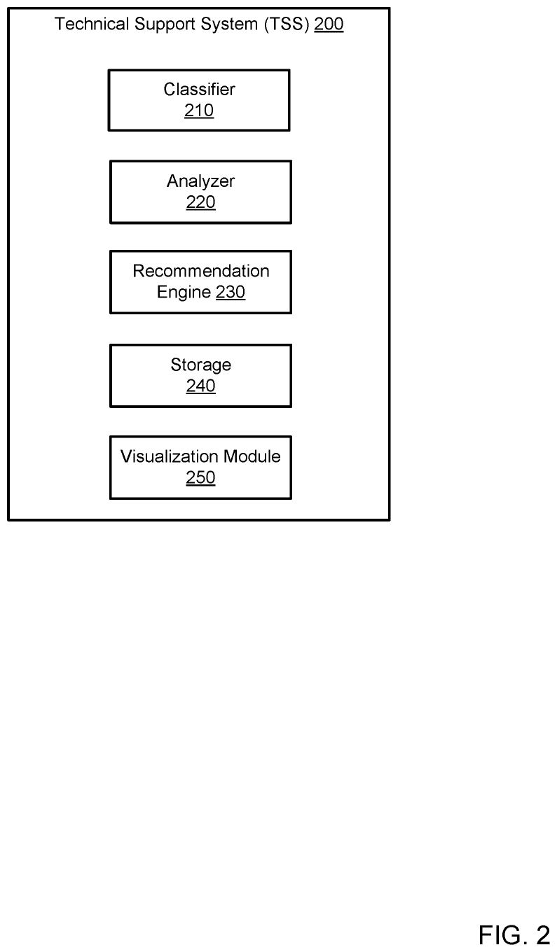

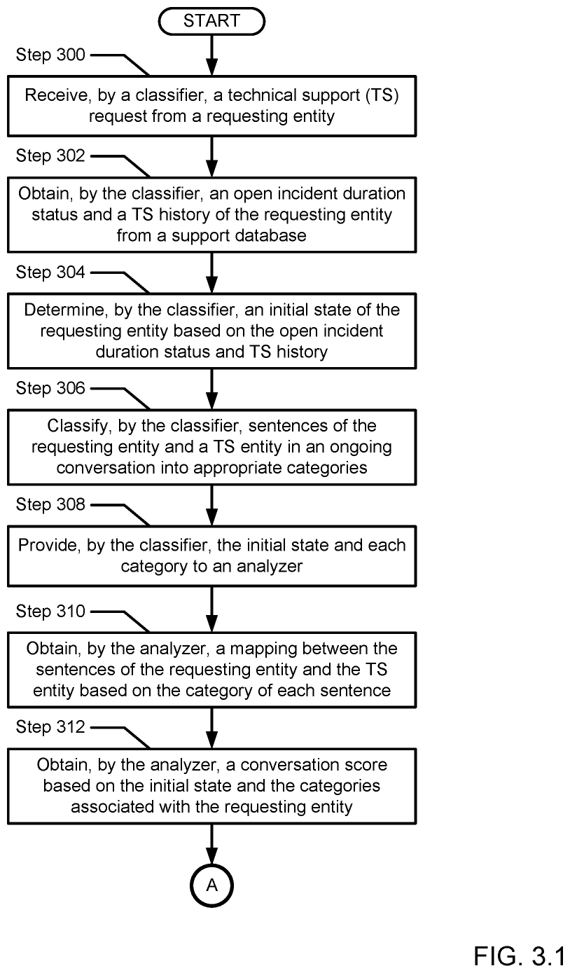

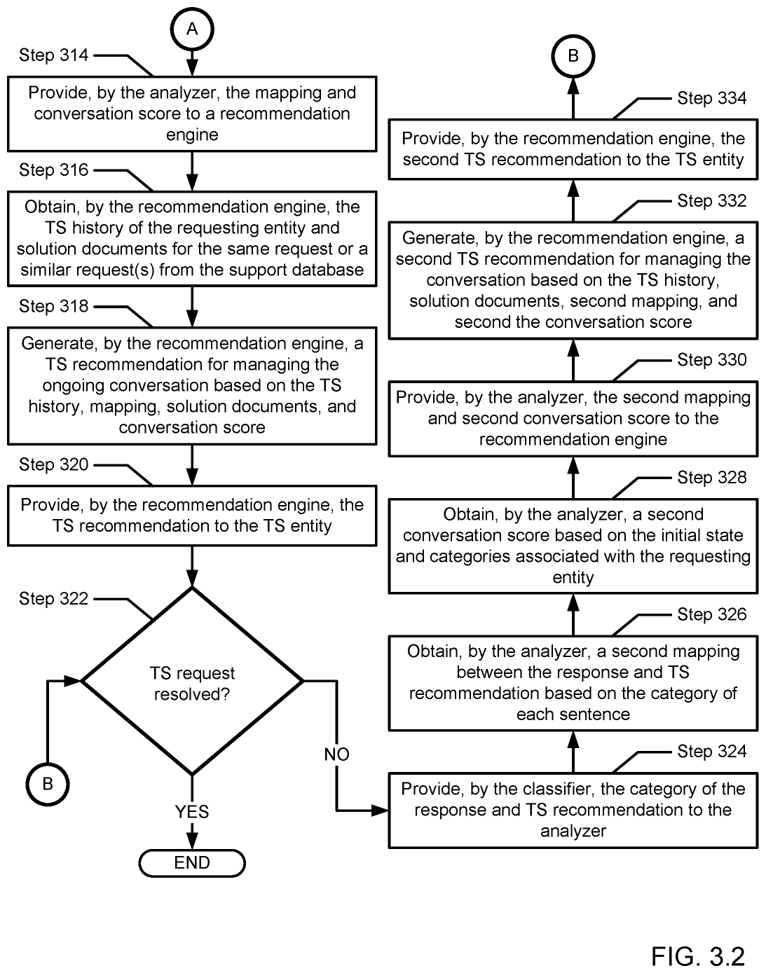

In one or more embodiments, each of the TSSs (120) may refer to a system (either hosted by a TSP's computing device or by a third party entity) that is used by the TSP to interact with customers (via the clients (110)) in order to resolve TSIs. In one or more embodiments, the TSSs (120) may be configured to perform all, or a portion, of the functionality described in FIGS. 3.1 and 3.2. Additional details about the TSSs are described below in reference to FIG. 2.

In one or more embodiments, the TSSs (120) may be implemented as computing devices (e.g., 500, FIG. 5). A computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the TSSs (120) described throughout this application.

Alternatively, in one or more embodiments, similar to the clients (110), the TSSs (120) may also be implemented as logical devices.

In one or more embodiments, the shared storage (130) (i) may be a storage or memory resource (discussed above) and (ii) may act as a support database (e.g., a solution service) that is functional to store unstructured and/or structured data. In one or more embodiments, the unstructured and/or structured data may include, for example (but not limited to): a service level agreement, an existing knowledge base (KB) article, a TS history documentation of a customer, recently obtained customer activity records, a cumulative history of customer activity records obtained over a prolonged period of time, a port's user guide, a port's release note, a community forum question and its associated answer, a user posted approximated port activation time, details of a remediative action that is applied to a previous hardware component failure, a version of a security fix, a version of an application upgrade, a TSS log, a model name of a hardware component, a catalog file of an application upgrade, details of a compatible OS version for an application upgrade to be installed, an application upgrade sequence, a solution or a workaround document for a software failure, etc.

In one or more embodiments, the unstructured and/or structured data may be updated (automatically) by third party systems (e.g., platforms, marketplaces, etc.) (provided by vendors) based on, for example, newer (e.g., updated) versions of application upgrades being available. The unstructured and/or structured data may also be updated when, for example (but not limited to): a newer version of an existing KB article is published, a support ticket (e.g., a reported incident) is resolved, a comment is received for a support ticket, a TSI is resolved by a recommended solution (e.g., by a recommended fix), a TS request is not resolved by a recommended solution, etc.

In one or more embodiments, the shared storage (130) is an example of a solution service. As discussed above, the solution service may be implemented as a support database; however, the solution service may also be implemented as any other computing device (e.g., 500, FIG. 5) (or a set of computing devices) that stores the unstructured and/or structured data. The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the solution service described throughout this application.

Alternatively, in one or more embodiments, similar to the clients (110), the solution service may also be implemented as a logical device.

In one or more embodiments, similar to the communication between a TSS (e.g., 120A, 120N) and the shared storage (130), the TSS (e.g., 120A, 120N) may also send a request to the solution service, and in return, the TSS (e.g., 120A, 120N) may receive a response from the solution service.

In one or more embodiments, the shared storage (130) may include an agent (not shown). The agent may be configured to analyze the updated unstructured and/or structured data and to store them into the shared storage (130). Further, based on a context-aware search performed in the shared storage (130), the agent may provide an exact or the most relevant (e.g., suitable) solution, for example, for a hardware component failure. In one or more embodiments, agent may be implemented using hardware, software, or any combination thereof.

In one or more embodiments, the shared storage (130) may be implemented as a computing device (e.g., 500, FIG. 5). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the shared storage (130) described throughout this application.

Alternatively, in one or more embodiments, similar to the clients (110), the shared storage (130) may also be implemented as a logical device.

Turning now to FIG. 2, FIG. 2 shows a diagram of a TSS (200) in accordance with one or more embodiments of the invention. The TSS (200) may be an example of the TSS discussed above in reference to FIG. 1. The TSS (200) may include a classifier (210), an analyzer (220), a recommendation engine (230), storage (240), and a visualization module (250). The TSS (200) may include additional, fewer, and/or different components without departing from the scope of the invention. Each component may be operably connected to any of the other component via any combination of wired and/or wireless connections. Each component illustrated in FIG. 2 is discussed below.

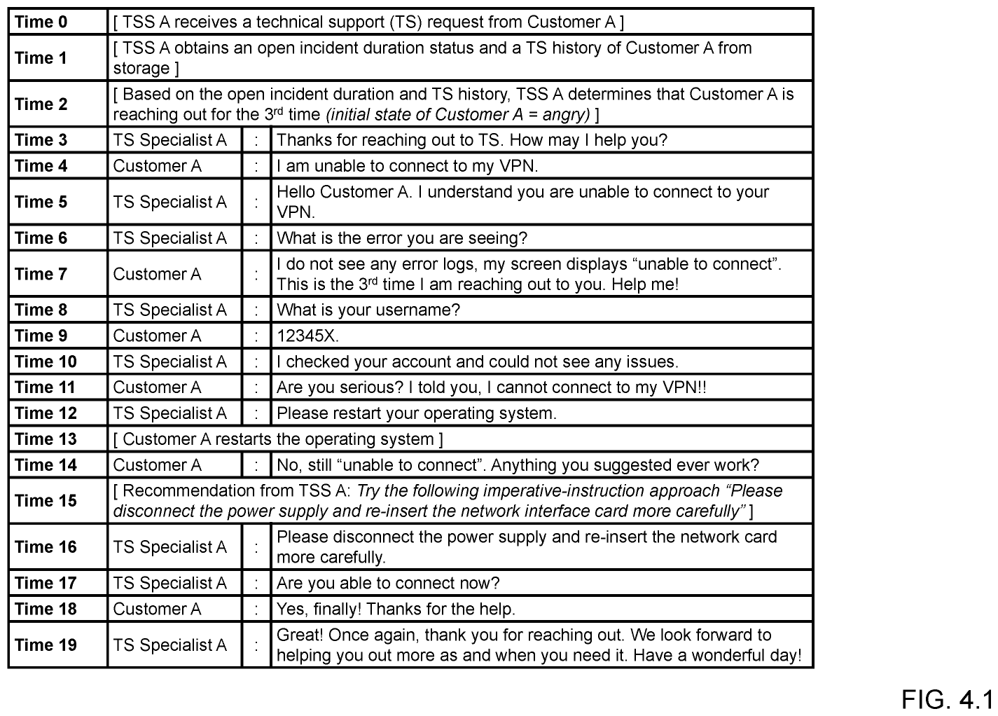

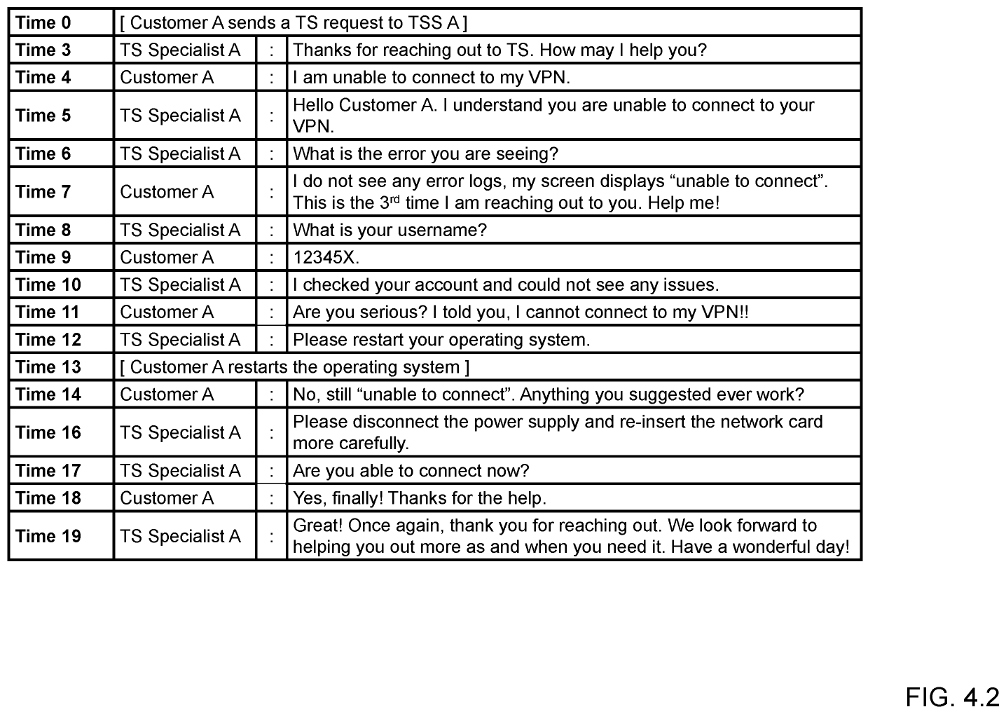

In one or more embodiments, the classifier (210) may be any hardware, software, or any combination thereof that includes functionality to receive a TS correspondence(s) (e.g., request(s)) in real-time (e.g., on the order of milliseconds or less) or near real-time. The TS correspondence may correspond to a question, an answer, or any other communication that is generated by a customer and sent to a TS entity as a part of a current (e.g., ongoing, live, etc.) TS session. Examples of TS correspondences are provided below in reference to FIG. 4.1.

In one or more embodiments, a TS correspondence may be received in the form of digital audio data, text corresponding to a transcription of an audio signal (regardless of the type of audio signal), and/or text generated by a customer and sent, via a client (e.g., 110A, FIG. 1), to the classifier (210). In one or more embodiments, while sending a TS correspondence, the client (e.g., 110A, FIG. 1) may use various different support channels (e.g., paths), for example (but not limited to): chat support channels, voice support channels, virtual support channels, etc.

In one or more embodiments, a TS correspondence may be generated on a client (e.g., 110A, FIG. 1) by encoding an audio signal in a digital form and then converting the resulting digital audio data into one or more TS correspondences. The conversion of the digital audio data into one or more TS correspondences may include applying an audio codec to the digital audio data, in order to compress the digital audio data prior to generating the TS correspondences. Further, the use of the audio codec may enable a smaller number of TS correspondences to be sent to the classifier (210).

In one or more embodiments, the audio signal may be obtained from a customer speaking into a microphone on the client (e.g., 110A, FIG. 1). Alternatively, the audio signal may correspond to a pre-recorded audio signal that the customer provided to the client (e.g., 110A, FIG. 1) using conventional methods. In one or more embodiments, the client (e.g., 110A, FIG. 1) may receive the digital audio data directly instead of receiving an analog audio signal. In other embodiments, the audio signal may be computer generated.

In one or more embodiments, the audio signal may include one or more audio utterances. As used herein, an “audio utterance” may refer to a unit of speech bounded by silence. The utterance may be a word, a clause, a sentence, or multiple sentences. Further, a “text utterance” may refer to a unit of speech (in a text form) that is provided by a customer or a computing system, in which the unit of speech may be a word, a clause, a sentence, or multiple sentences. Embodiments of the invention may apply to both types of utterances. Unless otherwise specified, “utterance” means either an audio utterance, a text utterance, or a combination thereof.

In one or more embodiments, if a TS correspondence is an audio signal, the classifier (210) may convert the audio signal into text using any known or later discovered speech-to-text conversion application (which may be implemented in hardware, software, or any combination thereof), in order to process the audio signal and extract relevant data from it. Thereafter, the classifier (210) may store the extracted data temporarily (until an ongoing TS conversation is over) or permanently in the storage (240).

In one or more embodiments, even if the classifier (210) may receive TS correspondences from a client (e.g., 110A, FIG. 1) in any format, the result of the processing of the received TS correspondences may be a text format of the TS correspondences. The text format of the TS correspondences may then be used by the other components (e.g., the analyzer (220), the recommendation engine (230), etc.) of the TSS (200).

In one or more embodiments, once a TS correspondence is converted into a text format, the TS correspondence may be cleaned (e.g., by the classifier (210)). Cleaning the TS correspondence may include identifying and correcting grammatical and/or punctuation mistakes. For example, the TS correspondence (“I does not see any error logs but it show ‘Unable to connect’. Can you please tell me how to connect with the VPN.”) may be corrected as (“I do not see any error logs but it shows ‘Unable to connect’. Can you please tell me how to connect with the VPN?”).

While not required, by cleaning TS correspondences prior to passing the TS correspondences to other components of the TSS (200), the other components of the TSS (200) may be able to more accurately process the TS correspondences to determine, for example, whether there are duplicate TS correspondences.

In one or more embodiments, the classifier (210) may further include functionality to classify a TS correspondence (e.g., a TS sentence, a customer sentence, etc.) and an associated TSP response (e.g., a TSP sentence) into suitable categories (and subcategories) in order to extract useful information from both sentence types. In one or more embodiments, the classifier (210) may classify a TSP sentence into one of the following categories: (i) an “interrogative TSP sentences” category, (ii) a “declarative TSP sentences” category, and (iii) an “imperative TSP sentences” category, in which the “imperative TSP sentences” category includes (a) an “imperative-request sentences” subcategory, (b) an “imperative-instruction sentences” subcategory, and (c) an “imperative-advice sentences” subcategory.

In one or more embodiments, the classifier (210) may employ a set of linear, non-linear, and/or machine learning (ML) models to classify TS and TSP sentences into their appropriate categories. For this purpose, for example, the classifier (210) may execute a Support Vector Machines (SVM) model. As used herein, the “SVM” model operates by mapping data to high-dimensional feature space so that data points may be categorized, even when the data are not otherwise linearly separable. A separator between the categories may be found and the data may then be transformed in such a way that the separator could be drawn as a hyperplane. Following this, characteristics of the transformed data may be used to predict the category to which the transformed data should belong.

In one or more embodiments, in order to classify TS and TSP sentences, the classifier (210) may be trained using any form of training data (e.g., TS and TSP sentences from previous TS sessions). In order to train, the above-mentioned models and/or other known or later discovered models may be employed. Further, the classifier (210) may be updated periodically as there are improvements in the models and/or the models are trained using more appropriate training data.

In one or more embodiments, the classifier (210) may classify a TS sentence into one of the following categories: (i) an “interrogative TS sentences” category, in which the “interrogative TS sentences” category includes (a) an “interrogative-mistrust sentences” subcategory and (b) an “interrogative-issue related sentences” subcategory; (ii) a “declarative TS sentences” category, in which the “declarative TS sentences” category includes (a) a “declarative-mistrust sentences” subcategory and (b) a “declarative-issue related sentences” subcategory; (iii) an “imperative TS sentences” category, in which the “imperative TS sentences” category includes an “imperative-mistrust sentences” subcategory; and (iv) a “duplicative sentences” category.

In one or more embodiments, example sentences included in the “interrogative TSP sentences” category may be (but not limited to): “Thanks for reaching out to TS. How may I help you?”, “What is the error you are seeing?”, “What is your username?”, etc. Example sentences included in the “declarative TSP sentences” category may be (but not limited to): “Hello Customer. I understand you are unable to connect to your VPN.”, “I checked your account and see there are no issues with your account.”, etc. Further, example sentences included in the “imperative TSP sentences” category may be (but not limited to): “Please share the details of your technical issue so that we can provide a better solution for you.” (e.g., an imperative-request sentence), “Please try out the command and let us know.” (e.g., an imperative-request sentence), “Please disconnect the power supply.” (e.g., an imperative-instruction sentence), “Please re-insert the network interface card more carefully.” (e.g., an imperative-advice sentence), etc.

In one or more embodiments, example sentences included in the “interrogative TS sentences” category may be (but not limited to): “Will the command that you suggested ever work?” (e.g., an interrogative-mistrust sentence), “What should be the next step that I need to do?” (e.g., an interrogative-issue related sentence), etc. Example sentences included in the “declarative TS sentences” category may be (but not limited to): “I am unable to connect to my VPN” (e.g., a declarative-issue related sentence), “This VPN never works!” (e.g., a declarative-mistrust sentence), “The step you suggested was not working.” (e.g., a declarative-issue related sentence), “I do not see any error logs; my screen displays ‘unable to connect’.” (e.g., a declarative-issue related sentence), etc. Further, example sentences included in the “imperative TS sentences” category may be (but not limited to): “This is the third time I am reaching out to you. Help me!” (e.g., an imperative-mistrust sentence), “Are you serious? I told you. I cannot connect to my VPN! Just help me!” (e.g., an imperative-mistrust sentence), etc.

In one or more embodiments, the classifier (210) may also include functionality to determine whether a pair of TS sentences (i.e., a TS sentence that was most recently received and a previously received TS sentence) are duplicative. To this end, the classifier (210) may perform a duplication analysis on the TS sentence that was most recently received and all (or at least a portion) of the previously received TS sentences for the TS session. The result of processing the received TS sentence is an identification of zero, one, or more pairs of duplicative TS sentences. For example, the classifier (210) may determine that the following interrogative TS sentences are duplicative (with varying confidence levels) and may also classify them into the “duplicative sentences” category:
Customer: “Global VPN not working?”
Customer: “Can you please tell me how to connect with the VPN?”
Customer: “But I am unable to connect to Global VPN. Why?”
Customer: “But my VPN is not connecting. What should I do?”

For a future duplication analysis, the classifier (210) may store these duplicative sentences (including the number of them) in the storage (240).

In one or more embodiments, in order to perform a duplication analysis, the classifier (210) may be trained using any form of training data. In order to train, a set of linear, non-linear, ML, natural language processing (NLP) models and/or other known or later discovered models may be employed. Further, the classifier (210) may be updated periodically as there are improvements in the models and/or the models are trained using more appropriate training data.

In one or more embodiments, the classifier (210) may generate values for one or more input parameters for a given pair of TS sentences for a TS session, and then uses them as input into a ML model (e.g., a Light Gradient Boosting Machine model, the SVM model, etc.). The result of processing the aforementioned input values using the model may be a binary result, indicating whether or not the two TS sentences are duplicative (i.e., similar to each other).

In one or more embodiments, the agent of the shared storage (e.g., 130, FIG. 1) may receive various TS history related inputs (e.g., TS history details of customers) from a TSP and/or from a TS session. Upon receiving, the agent may analyze those inputs to generate an index(es) (e.g., a TS session index(es)) for previous TS sessions (also referred to as “historical TS sessions”) included in the inputs, in which the index(es) may include, for example (but not limited to): information about a customer associated with a historical TS session, a keyword extracted from a historical TS session that relate to a TSI, a TSI tag (i.e., a keyword that identify a TSI issue that was a subject of a TS session) provided by a TSP, etc. The index(es) may also include other information that may be used to efficiently identify the historical TS sessions. In one or more embodiments, the aforementioned data may be stored as “TS session metadata” in the shared storage (e.g., 130, FIG. 1) with the corresponding TS sessions. In one or more embodiments, the TS session metadata may be stored in a native language and/or in a default language (discussed below).

In one or more embodiments, as a TSP and a customer are started to interact to resolve a TSI (e.g., an incident), the classifier (210) may obtain (from the shared storage (e.g., 130, FIG. 1)) TS history details of this customer (e.g., details of historical TS sessions that were performed for this customer), which addressed the same TSI. By obtaining such TS history details in real-time or near real-time, the classifier (210) may determine an “open incident duration status” of this customer. For example, if this customer is reaching out to the TSS (200) for the fifth time within one month, the open incident duration status of this customer will be one month.

In one or more embodiments, the classifier (210) may act as a “behavioral enrichment layer”. More specifically, in the above-discussed example, based on the open incident duration status and the TS history details of this customer, the classifier (210) may determine an initial state (e.g., an emotional condition) of this customer as, for example, normal, sad, angry, or frustrated. Based on the above-discussed example, the classifier (210) may determine the initial state of this customer as “angry” because (i) the customer is reaching out for the fifth time within one month, (ii) the incident is not resolved yet, and (iii) the TS history details (e.g., overheating of SSD, a critical fan failure, etc.) indicate that previous TS sentences are categorized under one of the “mistrust sentences” categories (e.g., the interrogative-mistrust sentences category, the declarative-mistrust sentences category, or the imperative-mistrust sentences category).

In one or more embodiments, for example, if a customer is reaching out to the TSS (200) for the first time, the classifier (210) may determine the initial state of this customer as “normal” because (i) there is no TS history data that is available for this customer in the shared storage (e.g., 130, FIG. 1) and (ii) there is no incident that is not reported (e.g., ticketed) for this customer yet. As yet another example, if a customer is reaching out to the TSS (200) to know about a particular service, the classifier (210) may determine the initial state of this customer as “normal” because the customer has reached out to the TSS (200) to query information.

In one or more embodiments, the analyzer (220) may include functionality to: (i) obtain a conversation score, (ii) obtain a mapping between a TS sentence and a TSP sentence, and (iii) generate a trending graph. One of ordinary skill will appreciate that the analyzer (220) may perform other functionalities without departing from the scope of the invention. The analyzer (220) may be implemented using hardware, software, or any combination thereof. Additional details of the analyzer, conversation score, mapping, and trending graph are described below in reference to FIGS. 3.1 and 3.2.

In one or more embodiments, the recommendation engine (230) may act as a “management layer” and may include functionality to: (i) generate a TS recommendation based on a TS history of a customer, a mapping between a TS sentence and a TSP sentence, one or more issue-related solution documents (e.g., KB articles, release notes, etc.) available in the shared storage (e.g., 130, FIG. 1), and a conversation score obtained by the analyzer (220), (ii) manage (e.g., change) the course of an ongoing TS conversation (in a positive way) to provide a better customer experience, and (iii) obtain feedback from a TS entity (to determine whether the TS request is resolved by the TS recommendation). Further, the recommendation engine (230) may store the TS recommendation in the storage (240) in order to provide it to the TSP.

One of ordinary skill will appreciate that the recommendation engine (230) may perform other functionalities without departing from the scope of the invention. The recommendation engine (230) may be implemented using hardware, software, or any combination thereof. Additional details of the recommendation engine are described below in reference to FIGS. 3.1 and 3.2.

In one or more embodiments, the TSS (200) may further include a TSP support module (not shown) that includes functionality to: (i) analyze TS sessions being conducted by a TSP, (ii) analyze historical TS sessions, and (iii) identify relevant historical TS sessions that may be use of the TSP in resolving an issue in a current TS session. Based on the analysis, the TSP support module may provide feedback to one or more TSPs to improve their TS session management skills (e.g., capabilities). In one or more embodiments, the TSP support module may be implemented using hardware, software, or any combination thereof.

In one or more embodiments, the storage (240) corresponds to any type of volatile or non-volatile (i.e., persistent) storage device that includes functionality to store, for example, a TS sentence that is classified as an “imperative-mistrust sentence” (discussed above). The storage (240) may also store a corresponding response (e.g., a TSP sentence) to that TS sentence.

For example, consider a scenario in which the following TS sentence is received by the TSS (200):
Customer: “Can you please tell me how to connect with the VPN?”

In response to this TS sentence, the TSP replies:
TSP: “Okay, I checked your account and see there are no issues with your account.”

In the above-discussed example, (i) the TS sentence is classified as an “interrogative TS sentence” (discussed above) and then is stored in the storage (240), and (ii) the TSP sentence is classified as a “declarative TSP sentence” (discussed above) and then is stored in the storage (240).

In addition to storing TS and TSP sentences (on a per-TS session basis), the storage (240) may also store, for example (but not limited to): information that identifies a TS session, a time stamp for a TS sentence, a time stamp for a TSP sentence, a locally-generated TS session (i.e., a TS session generated by a TSP using a local TSS), a remotely-generated TS session (i.e., a TS session generated by a TSP using a remote TSS), TS session metadata associated with a locally-generated TS session, TS session metadata associated with a remotely-generated TS session, data related to a trending graph, data related to a mapping between a TS sentence and a TSP sentence, data related to an initial state of a customer, an index to enable efficient identification and retrieval of content stored in the storage (240), etc. In one or more embodiments, the content may be stored in a native language and/or in a default language (discussed below).

In one or more embodiments, the storage (240) may maintain TS and TSP sentences for the duration of an associated TS session. The TS sentences (and, if stored, the associated TSP sentences) are maintained (or exported) and then used to train (or update the training of) the analyzer (220) so that, for example, (i) the analyzer (220) may provide accurate mapping results to the recommendation engine (230) and (ii) the recommendation engine (230) may provide a suitable TS recommendation to the corresponding TS entity (e.g., the TSP).

In one or more embodiments, the storage (240) may be a storage or memory resource. Details of the storage or memory resource have been described above in reference to FIG. 1.

In one or more embodiments, while providing the above-discussed functionalities, the classifier (210), the analyzer (220), and the recommendation engine (230) may store data (e.g., content) that may be relevant to the customer (e.g., customer-relevant content) in the storage (240). When customer-related content (simply “content”) is stored, the content may be subjected to loss, inaccessibility, or other undesirable characteristics based on the operation of the storage (240). To mitigate, limit, and/or prevent such undesirable characteristics, an administrator of the TSS (200) may enter into agreements (e.g., service level agreements) with a provider of the storage (240). These agreements may limit the potential exposure of the content to undesirable characteristics. These agreements may, for example, require duplication of the content to other locations so that if the storage (240) fails, another copy (or other data structure usable to recover the data on the storage (240)) of the content may be obtained. These agreements may specify other types of activities to be performed with respect to the storage (240) without departing from the scope of the invention.

In one or more embodiments, the visualization module (250) may include functionality to: (i) receive TS sentences (or clean TS sentences) and corresponding TSP sentences, and display the aforementioned content on its GUI (which is the GUI of the TSS (200)) as a visual stream (see FIG. 4.1) that is ordered by time, (ii) visually indicate (highlight or link) duplicative TS sentences within the visual stream, and/or in a separate window(s) on the GUI (e.g., one per set of duplicative TS sentences), and (iii) enable the TSP to receive real-time or near real-time visual feedback on the TSS (200) while conducting a TS session. In one or more embodiments, the visualization module (250) may not modify a visual stream of a TS session; rather, the visualization module (250) may concurrently display one or more separate windows on the GUI that show the duplicative TS sentences and the corresponding TSP sentences.

In one or more embodiments, if a TSP is concurrently handling multiple TS sessions, then the visualization module (250) may perform the aforementioned functionality on a per TS session basis. Further, the visualization module (250) may include functionality to generate visualizations of methods illustrated in FIGS. 3.1 and 3.2.

One of ordinary skill will appreciate that the visualization module (250) may perform other functionalities without departing from the scope of the invention. Although the visualization module (250) is shown as part of the TSS (200), the visualization module (250) may also be implemented separately in the form of hardware, software, or any combination thereof.

In one or more embodiments, the TSS (200) may further include a translator (not shown). The translator is configured to: (i) translate locally-generated TS sessions from a native language of the TSS (200) to a default language and (ii) translate remotely-generated TS sessions from a default language to the native language of the TSS (200). In one or more embodiments, the native language of the TSS (200) is the language that a TSP uses in a TS session to communicate with a customer. Further, the default language corresponds to the language into which the content from the storage (240) is translated prior to being exported. A default language is used in order to have a common language while exporting content to other TSSs and while importing other content from other TSSs. By using a common language, individual TSSs may only need to translate between the default language and their native language, instead of being required to implement translation between any arbitrary language and a native language of a TSS. If the TSS' native language is the same as the default language, then the translator may not be utilized. In one or more embodiments, the translator may be implemented using hardware, software, or any combination thereof.

FIGS. 3.1 and 3.2 show a method for improving customer experience with a TS entity in accordance with one or more embodiments of the invention. While various steps in the method are presented and described sequentially, those skilled in the art will appreciate that some or all of the steps may be executed in different orders, may be combined or omitted, and some or all steps may be executed in parallel without departing from the scope of the invention.

Turning now to FIG. 3.1, the method shown in FIG. 3.1 may be executed by, for example, the above-discussed classifier (e.g., 210, FIG. 2) and analyzer (e.g., 220, FIG. 2). Other components of the system (100) illustrated in FIG. 1 may also execute all or part of the method shown in FIG. 3.1 without departing from the scope of the invention.

In Step 300, the classifier receives a TS request from a requesting entity (e.g., a customer). The customer may send the TS request because of a TSI occurred in a client (e.g., 110A, 110N, etc.) and/or an alert (e.g., a predictive alert, a proactive alert, a technical alert, etc.) triggered in a client. In one or more embodiments, the TSI may be, for example (but not limited to): printed circuit board (PCB) failure, overheating of a DPU, etc. The alert may specify, for example (but not limited to): a medium level of DPU overheating is detected, a recommended maximum DPU operating temperature is exceeded, etc.

In one or more embodiments, the alerts may be defined by a vendor of that client, by the administrator, by another entity, or any combination thereof. The alerts may be defined based on a data protection policy.

In one or more embodiments, the TS request may include, for example (but not limited to): information related to a TSI, information related to a technical alert, information related to a customer (e.g., username of a customer, a product number of the customer's computing device, etc.), etc. In one or more embodiments, the classifier may display the TS request to a TSP (or to another TS entity) via the GUI of the visualization module (e.g., 250, FIG. 2), which is the GUI of the TSS (e.g., 200, FIG. 2). The visualization module may display the TS request to the TSP in real-time or near real-time.

In one or more embodiments, upon receiving the TS request, the classifier may generate a support ticket and identify one or more keywords from the TS request to generate a “TS request tag” specifying the subject of a soon-to-start TS session. The keywords may be identified by: (i) prompting the TSP to identify keywords, (ii) using a ML algorithm(s) to extract keywords from the TS request, and/or (iii) using (ii) to identify a set of keywords and then having the TSP confirm (or remove) the keywords that were identified to obtain a verified set of keywords. The keyword identification may be implemented using any combination of the above mechanisms and/or any other mechanisms without departing from the scope of the invention.

In Step 302, in response to the TS request (received in Step 300), the classifier obtains an open incident duration status and a TS history of the customer from the shared storage (e.g., 130, FIG. 1). In one or more embodiments, in order to obtain the open incident duration status and TS history of the customer, the classifier may make an application programming interface (API) call to the agent of the shared storage. As used herein, an “API call” may refer to a process of an application or a computing device submitting a request to an API to retrieve the requested data from an external application or an external computing device.

Based on receiving the API call (including information from the TS request and TS request tag) from the classifier, the agent may perform a search to identify one or more historical TS sessions (related to the customer) in the shared storage. In one or more embodiments, the agent may perform the search using the index discussed above in reference to FIG. 2. As a result of the search, the agent may identify (or may not identify) one or more historical TS sessions related to the customer and an open incident duration status of the customer. If the agent could not identify any historical TS sessions related to the customer and the open incident duration of the customer, the agent may then request additional information (e.g., additional information from the TS request) from the classifier to perform an updated search.

In one or more embodiments, if the agent still could not identify the above, as a response to the API call, the agent may notify the classifier by indicating (i) there is no TS history data available for this customer and (ii) there is no incident that is reported for this customer yet. In one or more embodiments, if the agent has identified one or more historical TS sessions related to the customer and the open incident duration status of the customer, as a response to the API call, the agent may send the identified TS sessions (as well as the corresponding TS session metadata) and the open incident duration status to the classifier.

In one or more embodiments, upon receiving the above from the agent, the classifier may display at least a portion of the TS history and the open incident duration status to the TSP via the GUI of the TSS. For example, the GUI may display a listing of all (or a portion) of the identified historical TS sessions along with their rankings. Alternatively, the GUI may display only the successful historical TS sessions or the historical TS sessions with the corresponding values above a certain threshold (e.g., 8 out of 10, where 10 indicates a fully successful TS session). In one or more embodiments, before displaying the identified historical TS sessions, the identified historical TS sessions may be translated from a native language to a default language.

In Step 304, the classifier determines an initial state of the customer based on the open incident duration status and TS history of the customer. For example, consider a scenario where a customer is reaching out to the TSS for the third time within a week. Based on that, the classifier will obtain, from the agent, “one week” as the open incident duration status of this customer. In this scenario, based on the open incident duration status and the TS history details of this customer, the classifier may determine the initial state of this customer as “angry” because (i) the customer is reaching out for the third time within a week, (ii) the incident (e.g., the TSI, the technical alert, etc.) is not resolved yet, and (iii) the TS history details (e.g., PCB failure, overheating of the DPU, etc.) indicate that previous TS sentences are categorized under the declarative-mistrust sentences category.

In one or more embodiments, upon determining the initial state of the customer, the classifier may display the initial state of the customer to the TSP via the GUI of the TSS. In this manner, the TSP will know the initial state of the customer even before interacting with the customer (e.g., even before the actual TS session starts).

In Step 306, in an ongoing TS session, the classifier classifies sentences of the customer and TSP (e.g., the TS and TSP sentences) into appropriate categories. In one or more embodiments, as part of the ongoing TS session, if the received TS correspondence is an audio signal, the classifier may first convert the audio signal into a text format to obtain the TS sentence. Thereafter, the TS sentence may be cleaned to obtain a cleaned TS sentence (if necessary). Once the TS sentence is cleaned (or after receiving an already clean TS sentence), the TS sentence may be provided to the visualization module to display as part of a visual stream (see FIG. 4.1). Details of the cleaning process are described above in reference to FIG. 2.

Further, before classifying the sentences into their corresponding categories and after the cleaning (if it was performed), the classifier may make a determination about whether the sentences are in a default language. As discussed above, in order to facilitate the sharing of the sentences (e.g., once the TS session is ended) between other TSSs, each TS session may be exported using a common language (referred to the default language). To this end, if the sentences (and TS session metadata) are not in the default language, the classifier may send a request to the translator to translate them into the default language (e.g., English).

Thereafter, the TS sentences (which may or may not be cleaned or translated) and TSP sentences (which may or may not be cleaned or translated) are classified into their corresponding categories. For example, “Thanks for reaching out to TS. How may I help you?” and “What is the issue with your DPU?” may be classified into the “interrogative TSP sentences” category. As yet another example, “This is the third time I am reaching out to you. Help me!” and “Are you serious? I told you. My DPU is not functioning properly anymore. Just help me!” may be classified into the “imperative-mistrust TS sentences” subcategory.

The aforementioned examples are not intended to limit the scope of the invention.

Further, by implementing a duplication analysis, the classifier may determine whether a pair of the TS sentences (in the ongoing TS session) are duplicative. If this is the case, the classifier may also classify them into the duplicative sentences category. For example, the classifier may determine that the following imperative-mistrust TS sentences are duplicative and may also classify them into the duplicative sentences category: “This is the third time I am reaching out to you. Help me!” and “Third time I am reaching out to you. Still no help!”. For a future duplication analysis, the classifier may store these duplicative sentences (including the number of them) in the storage (e.g., 240, FIG. 2).

In one or more embodiments, while streaming (in real-time or near real-time) the ongoing TS session to the TSP, the visualization module may highlight the duplicative sentences (e.g., using a different color, using a different font, etc.) so that the TSP may act accordingly.

In Step 308, the classifier provides the initial state of the customer (determined in Step 304) and the category of each of the TS and TSP sentences (obtained in Step 306) to the analyzer. In one or more embodiments, before providing the above to the analyzer, the classifier may store them in the storage (temporarily or permanently).

In Step 310, the analyzer obtains a mapping between the TS and TSP sentences based on the category of each sentence. For example, consider a scenario where the TSP asked a question (e.g., an interrogative TSP sentence) to the customer and in response, the customer replied with a question (e.g., an interrogative-mistrust TS sentence). Thereafter, the TSP asked another question (e.g., an interrogative TSP sentence) to the customer and in response, the customer replied with another question (e.g., an interrogative-mistrust TS sentence), not with an answer (e.g., a declarative-issue related TS sentence). In this scenario, the mapping will be “interrogative (TSP)→interrogative (customer)”, which indicates that the interrogative approach followed by the TSP was not useful to resolve the TSI because the customer was still asking questions.

As yet another example, consider a scenario where the TSP asked a question (e.g., an interrogative TSP sentence) to the customer and in response, the customer replied with a mistrust sentence (e.g., a declarative-mistrust related TS sentence). Thereafter, the TSP asked another question (e.g., an interrogative TSP sentence) to the customer and in response, the customer replied with another question (e.g., an interrogative-mistrust TS sentence), not with an answer (e.g., a declarative-issue related TS sentence). In this scenario, the mappings will be “interrogative (TSP)→mistrust (customer)” and “interrogative (TSP)→interrogative (customer)”, which indicates that the interrogative approach followed by the TSP was not useful to resolve the TS request because the customer was replying with a mistrust sentence and a mistrust question.

In one or more embodiments, the mapping between the TS and TSP sentences may be, for example (but not limited to): interrogative (TSP)→mistrust (customer), declarative (TSP)→issue related (customer), imperative-request (TSP)→issue related (customer), declarative (TSP)→mistrust (customer), interrogative (TSP)→issue related (customer), etc.

In Step 312, the analyzer obtains a conversation score (e.g., a TS session score) based on the initial state of the customer and the categories associated with the customer. In one or more embodiments, the analyzer may employ a set of linear, non-linear, and/or ML models to obtain the conversation score. For example, the analyzer may execute a multiple linear regression model. As an extension of a “linear regression model”, the “multiple linear regression model” refers to a statistical method that is used to predict the outcome of a variable based on a value of one or more variables. The variable that needs to be predicted is known as the “dependent” variable, while the variables that are used to predict the dependent variable are known as “independent” or “explanatory” variables.

Based on the multiple linear regression model, initial state of the customer, categories associated with the customer, and corresponding coefficients, the analyzer may generate the following equation: initial state+coefficient_1×interrogative-mistrust+coefficient_2×interrogative-issue related+coefficient_3×declarative-mistrust+coefficient_4×declarative-issue related+coefficient_5×imperative-mistrust+coefficient_6×duplicative. In this equation, the categorized TS sentences may be multiplied with their respective occurrences in the ongoing TS session.

For example, consider a scenario where the customer's initial state is “angry” and so far, in the ongoing TS session, the TS sentences are classified into the “interrogative-issue related”, “declarative-issue related”, and “imperative-mistrust” categories. Based on these inputs, the analyzer may obtain a conversation score of 25, (which is above the “conversation score threshold” (e.g., 15)), mostly because of the initial state of the customer.

As yet another example, consider a scenario where the customer's initial state is “normal” and so far, in the ongoing TS session, the TS sentences are classified into the “interrogative-mistrust”, “declarative-mistrust”, and “imperative-mistrust” categories. Based on these inputs, the analyzer may obtain the conversation score of 17, (which is above the conversation score threshold), mostly because of the TS sentences.

In one or more embodiments, based on the obtained scores, the analyzer may generate a trending graph, in which the trending graph shows a status of the ongoing TS session. For example, if the conversation score is increasing as the TS session continues, the graph may indicate “negative communication with the customer”. As yet another example, if the conversation score is decreasing as the TS session continues, the graph may indicate “positive communication with the customer”. In one or more embodiments, upon generating the trending graph, the analyzer may display it to the TSP via the GUI of the TSS so that the TSP may act accordingly. The GUI may display the graph in real-time or near real-time.

Turning now to FIG. 3.2, the method shown in FIG. 3.2 may be executed by, for example, the above-discussed analyzer, classifier, and recommendation engine (e.g., 230, FIG. 2). Other components of the system (100) illustrated in FIG. 1 may also execute all or part of the method shown in FIG. 3.2 without departing from the scope of the invention.

In Step 314, the analyzer provides the mapping (obtained in Step 310 of FIG. 3.1) and conversation score (obtained in Step 312 of FIG. 3.1) to the recommendation engine.

In Step 316, upon receiving the mapping and conversation score, the recommendation engine obtains the TS history of the customer and solution documents for the same TS request (received in Step 300) or a similar request(s) from the shared storage. Said another way, the recommendation engine obtains an exact or the most relevant solution documents for the TS request from the shared storage.

In one or more embodiments, before obtaining the above, the recommendation engine may obtain the TS request and TS request tag from the classifier. Thereafter, in order to obtain the solution documents and TS history of the customer, the recommendation engine may make an API call (including information from the TS request and TS request tag) to the agent of the shared storage.

Based on receiving the API call from the recommendation engine, the agent may perform a search to identify one or more historical TS sessions (related to the customer) and solution documents (for the TS request) in the shared storage.

As a result of the search, the agent may identify (or may not identify) one or more historical TS sessions related to the customer (discussed above in reference to Step 302 of FIG. 3.1) and solution documents for the TS request. If the agent could not identify solution documents for the same TS request, the agent may then search for the most relevant solution documents for the TS request. Thereafter, as a response to the API call, the agent may send the identified TS sessions (as the TS history of the customer) and the solution documents (either the exact or the most relevant solution documents) to the recommendation engine.

In Step 318, in order to manage the ongoing TS session, the recommendation engine generates a TS recommendation based on the TS history of the customer, mapping, solution documents, and conversation score. In one or more embodiments, the TS recommendation may specify a solution (or an approach) that the TSP needs to initiate (or follow) (i) in order to manage the ongoing TS session more properly and (ii) in order to resolve the TS request.

In one or more embodiments, a solution may correspond to a software fix(es) to be installed on the client, a script to be executed on the client, solution documents about how to modify hardware configuration of the client to address the TS request, or any combination thereof.

For example, consider a scenario in which the following TSP sentence is received by the customer:
TSP: “Thanks for reaching out to TS. How may I help you?” (an interrogative TSP sentence)

In response to this TSP sentence, the customer replies:
Customer: “My VPN is not working.” (a declarative-issue related TS sentence)

In response to this TS sentence, the TSP replies:
TSP: “What is the error you are seeing?” (an interrogative TSP sentence)

In response to this TSP sentence, the customer replies:
Customer: “This VPN never works!” (a declarative-mistrust TS sentence)

In the above-discussed example, at this point, the recommendation engine recommends the following “TS recommendation” to the TSP: (“Try this imperative-request approach: Please share the details of your technical issue so that we can provide a better solution for you”). The recommendation engine recommends this TS recommendation because (i) the conversation score is above the threshold (which means the TSP's approach to resolve the TSI is not working), (ii) the initial state of the customer was “angry”, (iii) the customer is reaching out for the fourth time (based on the TS history of the customer) and some of other possible solutions/approaches (based on the solution documents) were already applied by the TSP, and (iv) the trending graph is indicating “negative communication with the customer”.

By following the recommended solution (or the recommended approach), the TSP may change the course of the ongoing TS session (in a positive way) in order to provide a better customer experience. In this manner, the TS request may be resolved or the next TS sentence may be more positive (e.g., not an interrogative-mistrust, declarative-mistrust, or imperative-mistrust sentence).

In Step 320, the recommendation engine provides the TS recommendation (generated in Step 318) to the TS entity (e.g., the TSP). In one or more embodiments, the recommendation engine may provide the TS recommendation by displaying it as a message to the TSP via the GUI of the TSS. The visualization module may display the message in real-time or near real-time so that the TSP may act accordingly. Said another way, the visualization module may display the message in real-time or near real-time in order to aid the TSP in successfully resolving the customer's issue (i.e., the TSI) in the ongoing TS session.

In Step 322, a determination is made as to whether the TS request (e.g., the customer's issue) is resolved (e.g., whether the TS session was successful). Accordingly, in one or more embodiments, if the result of the determination is YES, the method ends. If the result of the determination is NO, the method alternatively proceeds to Step 324.

In one or more embodiments, if the result of the determination is YES, the customer may receive, for example, the following TSP sentence from the TSP: (“Once again, thank you for reaching out. We look forward to helping you out more as and when you need it. Have a wonderful day!”). Thereafter, the classifier may make a determination that the TS session has ended. The determination may be made by prompting the TSP and/or the customer (in scenarios in which the customer provided feedback following the end of the TS session) to indicate whether the TS session was successful. The TS session may be determined to be successful if the TSP and/or the customer both indicate that the TSI that was the subject of the TS session was successfully resolved. The indication of success may be binary (i.e., the TS session was successful or unsuccessful) or may be denoted on a scale, e.g., a scale from 1-10, where 1 is not successful, 2-9 is partially successful, and 10 is completely successful.

Further, the TS session may be tagged with a “successful tag”. The successful tag may be added to metadata of this TS session. In the event that the indication of success is denoted on a scale, then the successful tag also includes that value.

In one or more embodiments, the TS session may be ended by the customer or by the TSP (e.g., by the customer not sending TS sentences for a pre-determined period of time, by the customer or TSP closing a communication session, etc.). Further, depending on how the TS session was conducted, ending the TS session may occur when the TSP and/or the customer closes a chat window, hangs up the phone, etc. The session may be ended in any other manner without departing from the scope of the invention.

Those skilled in the art will appreciate that the TSS may track all active TS sessions and determine whether they have ended; alternatively, the TSS may only track a subset of the TS sessions that are active on the TSS and determine when TS sessions in this subset have ended.

In one or more embodiments, if the TS session has ended, the classifier may extract one or more keywords from the TS session. The purpose of the keyword extraction is to identify words (or phrases) that may be used by other modules/engines in the TSS to identify the TS session (as a historical TS session) in future. To that end, any mechanism for determining keywords may be used without departing from the scope of the invention. For example, the keywords may be determined by: (i) prompting the TSP to identify keywords, (ii) using a ML algorithm(s) to extract keywords from the TS session, and/or (iii) using (ii) to identify a set of keywords and then having the TSP confirm (or remove) the keywords that were identified to obtain a verified set of keywords. The keyword extraction may be implemented using any combination of the above mechanisms and/or any other mechanisms without departing from the scope of the invention. In one or more embodiments, the extracted keywords may also be added to the above-discussed TS session metadata.

Further, if the TS session has ended, the TS session (which corresponds all the correspondence between the customer and TSP) may be stored along with the TS session metadata in the shared storage. The TS session and TS session metadata may be stored in a native language and/or in a default language. Further, a “TS session index entry” for the TS session may be generated and stored in the TS session index, which is maintained in the shared storage. The TS session index includes content that enables efficient identification and retrieval of the TS session and TS session metadata from the shared storage.

In one or more embodiments, if the ended TS session needs to be distributed to other TSSs, the translator may determine whether the TS session (and the corresponding TS session metadata) is in a default language (in order to facilitate the sharing of the TS session between the TSSs). If not, the translator may translate them from the native language to the default language.

Further, before distributing the TS session to other TSSs, a determination may be made as to whether any modification to the TS session and/or TS session metadata is required in view of, for example, sharing compliance rules. In one or more embodiments, the sharing compliance rules may specify that (i) all or a portion of the TS session and/or TS session metadata may not be exported to other TSSs and/or (ii) all or a portion of the TS session and/or the TS session metadata must be modified prior to exporting the TS session and/or the TS session to other TSSs. For example, based on the sharing compliance rules, (i) usernames and passwords may be removed, and (ii) certain types of questions and responses may be removed. As yet another example, based on the sharing compliance rules, certain portions of the TS session and/or TS session metadata may be modified, in which all personal identifiers may be redacted, removed, and replaced with anonymized identifiers. In this manner, the TS session and/or TS session metadata can still be used, but no personal information is exchanged.

In one or more embodiments, if the result of the determination is NO, the recommendation engine may be notified (by, for example, the TSP) that the TSI is not resolved by the TS recommendation. More specifically, the recommendation engine may solicit feedback from the TSP about, for example (but not limited to): whether a given TS session was successful or unsuccessful, a ranking of the success of a given TS session in resolving the TSI, whether the TS recommendation was helpful in ultimately resolving the TSI, the reason why the TS recommendation was unhelpful in ultimately resolving the TSI, etc. In one or more embodiments, rather than soliciting feedback from the TSP, the recommendation engine may monitor the client to infer the above.

Thereafter, the TS session may be tagged with an “unsuccessful tag”. The unsuccessful tag may be added to this TS session's metadata. In the event that the indication of success is denoted on a scale, then the unsuccessful tag also includes that value. Similar to the above-discussed metadata, the metadata of this TS session may also include one or more keywords from this TS session.

In Step 324, as a result of the determination in Step 322 being NO, the classifier provides the category of the response (received from the customer) and TS recommendation (provided in Step 320) to the analyzer. In one or more embodiments, before providing the above, the classifier (i) may clean the response and (i) may request the translator to translate the response into the default language (if necessary). Thereafter, the classifier may determine whether the response is a duplicative of one of the TS sentences that was stored in Step 306 of FIG. 3.1. The determination may be performed in substantially the same manner as FIG. 2.

In one or more embodiments, if the response is a duplicative of a TS sentence, the classifier may classify the response into the duplicative sentences category. The visualization module may then highlight the response (on its GUI while streaming the TS session) so that the TSP may act accordingly. Otherwise, for example, if the response is (“Similar to your previous suggestions, the step you just suggested was not solve my issue”), the classifier may then classify the response into the declarative-issue related sentences subcategory.

In Step 326, similar to Step 310 of FIG. 3.1, the analyzer obtains a second mapping between the response and TS recommendation based on the category of each sentence. In one embodiment, based on the above-discussed example in reference to Step 324, the mapping may show “imperative (TSP)→issue related (customer)”, which indicates the imperative-request course followed by the TSP was not useful to resolve the TSI request because the customer replied with an issue related sentence.

In Step 328, similar to Step 312 of FIG. 3.1, the analyzer obtains a second conversation score based on the initial state of the customer (determined in Step 304 of FIG. 3.1) and the categories associated with the customer. For example, because the customer's initial state is “angry” and so far, in the ongoing TS session, the TS sentences are classified into the “interrogative-issue related”, “declarative-issue related”, and “imperative-mistrust” categories, the analyzer may obtain the conversation score of 35, (which is above the conversation score threshold), mostly because of the TSI is not resolved yet.

In Step 330, similar to Step 314, the analyzer provides the second mapping (obtained in Step 326) and second conversation score (obtained in Step 328) to the recommendation engine.

In Step 332, upon receiving the second mapping and second conversation score, and in order to manage the ongoing TS session, the recommendation engine generates a second TS recommendation based on the TS history of the customer, second mapping, solution documents, and second conversation score. In one or more embodiments, the second TS recommendation may specify a solution (or an approach) that the TSP needs to initiate (or follow) (i) in order to manage the ongoing TS session more properly and (ii) in order to resolve the TS request. Comparing to the TS recommendation, for example, the second recommendation may recommend (“Try this imperative-instruction approach: Please disconnect the power supply and re-locate your heat sink more carefully”) to the TSP. The recommendation engine recommends this TS recommendation because (i) the conversation score is still above the threshold (which means the TS recommendation was unhelpful to resolve the TSI), (ii) initial state of the customer was “angry”, (iii) the customer is still waiting for a solution (based on the TS history of the customer) and some of other possible solutions/approaches (based on the solution documents) were already applied by the TSP, and (iv) the trending graph is still indicating “negative communication with the customer”.

By following the recommended solution (or the recommended approach), the TSP may change the course of the ongoing TS session (in a positive way). In this manner, the TS request may be resolved or the next TS sentence may be more positive.

In Step 334, similar to Step 320, the recommendation engine provides the second TS recommendation (generated in Step 332) to the TSP. In one or more embodiments, the recommendation engine may provide the second TS recommendation by displaying it as a message to the TSP via the GUI of the TSS. The visualization module may display the message in real-time or near real-time so that the TSP may act accordingly. Thereafter, the method proceeds to Step 322, where a second determination is made as to whether the customer's issue is resolved.

### Start of Example

The following section describes an example of one or more embodiments. The example, illustrated in FIGS. 4.1 and 4.2, is not intended to limit the scope of the embodiments disclosed herein and is independent from any other examples discussed in this application.

Turning now to FIG. 4.1, FIG. 4.1 shows an exemplary visual stream (from a perspective of the TSP (i.e., TS Specialist A)) in accordance with one or more embodiments of the invention. In the example shown in FIG. 4.1, the visual stream includes (i) background processes (at Time 0, Time 1, Time 2, Time 13, and Time 15), (ii) TS sentences of Customer A (at Time 4, Time 7, Time 9, Time 11, Time 14, and Time 18), and (iii) TSP sentences of TS Specialist A (at Time 3, Time 5, Time 6, Time 8, Time 10, Time 12, Time 16, Time 17, and Time 19). In this example, the visual stream is for a TS session that starts at Time 0 and ends at Time 19 (i.e., the TSP ends the TS session), and the visual stream is displayed by TSS A's GUI.

At Time 0, the customer (i.e., Customer A) sends a TS request to TSS A, in which the request itself is not displayed in the visual stream. At Time 1, in response to receiving the TS request, TSS A obtains open incident duration status and a TS history of the customer from the shared storage, in which the open incident duration status and TS history of the customer are not displayed in the visual stream. At Time 2, based on the open incident duration status and TS history of the customer, TSS A determines that the customer is reaching out for the third time within a week and because of that, TSS A determines an initial state of the customer as “angry”, in which TSS A may display the initial state of the customer to the TSP on a separate window on the GUI even before the actual TS session starts.

At Time 3, the TSP sends a TSP sentence (“Thanks for reaching out to TS. How may I help you?”), which is displayed in the visual stream. At Time 4, the customer replies with a TS sentence (“I am unable to connect to my VPN.”), which is displayed in the visual stream. At Time 5-Time 12, additional TS and TSP sentences are exchanged, which are displayed in the visual stream. At Time 13, the customer applies the step suggested by the TSP at Time 12 and restarts the OS of the client. Thereafter, at Time 14, the customer sends a TS sentence (“No, still “unable to connect”. Anything you suggested ever work?”), which is displayed in the visual stream. After receiving this TS sentence and in order to change the course of the ongoing TS session (in a positive way), TSS A generates a TS recommendation based on (i) the TS history of this customer, (ii) mappings between the TS and TSP sentences that are exchanged in the TS session, (iii) TS request related solution documents that are obtained from the shared storage, and (iv) a conversation score of the ongoing TS session. In light of (i)-(iv), TSS A sends the following TS recommendation to the TSP: “Try the following imperative-instruction approach “Please disconnect the power supply and re-insert the network interface card more carefully””. At Time 16, upon receiving the recommendation from TSS A, the TSP sends the TS recommendation to the customer, which is displayed in the visual stream.

Thereafter, as a follow-up, at Time 17, the TSP sends a TSP sentence (“Are you able to connect now?”), which is displayed in the visual stream. At Time 18, the customer replies with a TS sentence (“Yes, finally! Thanks for the help.”). At Time 19, as a courtesy, the TSP replies with the TSP sentence (“Great! Once again, thank you for reaching out. We look forward to helping you out more as and when you need it. Have a wonderful day!”), which is displayed in the visual stream. The TS session may then be ended by the TSP.

Turning now to FIG. 4.2, FIG. 4.2 shows an exemplary visual stream (from a perspective of the customer) in accordance with one or more embodiments of the invention. In the example shown in FIG. 4.2, the visual stream includes (i) background processes (at Time 0 and Time 13), (ii) TS sentences of Customer A (at Time 4, Time 7, Time 9. Time 11, Time 14, and Time 18), and (iii) TSP sentences of TS Specialist A (at Time 3, Time 5. Time 6, Time 8, Time 10. Time 12, Time 16, Time 17, and Time 19). In this example, the visual stream is for the TS session that starts at Time 0 and ends at Time 19 (i.e., the TSP ends the TS session), and the visual stream is displayed by the client's GUI.

At Time 0, the customer sends the TS request to TSS A, in which the request itself is not displayed in the visual stream. In response to the TS request, at Time 3, the TSP sends the TSP sentence (“Thanks for reaching out to TS. How may I help you?”), which is displayed in the visual stream. At Time 4, the customer replies with the TS sentence (“I am unable to connect to my VPN.”), which is displayed in the visual stream. At Time 5-Time 12, additional TS and TSP sentences are exchanged, which are displayed in the visual stream. At Time 13, the customer applies the step suggested by the TSP at Time 12 and restarts the OS of the client. Thereafter, at Time 14, the customer sends the TS sentence (“No, still “unable to connect”. Anything you suggested ever work?”), which is displayed in the visual stream.

At Time 16, as a reply, the TSP sends the TSP sentence (“Please disconnect the power supply and re-insert the network interface card more carefully.”), which is displayed in the visual stream. As a follow-up, at Time 17, the TSP sends the TSP sentence (“Are you able to connect now?”), which is displayed in the visual stream. At Time 18, the customer replies with the TS sentence (“Yes, finally! Thanks for the help.”). At Time 19, as a courtesy, the TSP replies with the TSP sentence (“Great! Once again, thank you for reaching out. We look forward to helping you out more as and when you need it. Have a wonderful day!”), which is displayed in the visual stream. The TS session may then be ended by the TSP.

### End of Example

Turning now to FIG. 5, FIG. 5 shows a diagram of a computing device in accordance with one or more embodiments of the invention.

In one or more embodiments of the invention, the computing device (500) may include one or more computer processors (512), non-persistent storage (504) (e.g., volatile memory, such as RAM, cache memory), persistent storage (506) (e.g., a hard disk, an optical drive such as a CD drive or a DVD drive, a Flash memory, etc.), a communication interface (512) (e.g., Bluetooth interface, infrared interface, network interface, optical interface, etc.), an input device(s) (510), an output device(s) (508), and numerous other elements (not shown) and functionalities. Each of these components is described below.

In one or more embodiments, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (e.g., a LAN, a WAN, Internet, mobile network, etc.) and/or to another device, such as another computing device.

In one or more embodiments, the computing device (500) may include one or more output devices (508), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for managing a technical support (TS) conversation, the method comprising:
determining an initial state of a user based on a TS history of the user;
classifying a first sentence of a TS entity into a first category and a second sentence of the user into a second category;
obtaining, based on the first category and the second category, a mapping between the first sentence and the second sentence;
obtaining a TS conversation score based on the initial state and the second category;
generating a TS recommendation based on the TS history, the mapping, and the TS conversation score; and
initiating display of the TS recommendation on a graphical user interface (GUI) accessible to the TS entity.

2. The method of claim 1, further comprising:
obtaining the TS history, wherein the TS history specifies at least a previous TS recommendation generated for the user.

3. The method of claim 1, wherein the initial state of the user specifies an emotional condition of the user, wherein the emotional condition specifies at least one selected from a group consisting of normal, sad, angry, and frustrated.

4. The method of claim 1, wherein the first category is an imperative sentences category, wherein the imperative sentences category comprises an instruction sentences subcategory and an advice sentences subcategory.

5. The method of claim 4, wherein the advice sentences subcategory comprises at least the TS recommendation.

6. The method of claim 1, wherein the second category is an interrogative sentences category, wherein the interrogative sentences category comprises a mistrust sentences subcategory and an issue related sentences subcategory.

7. The method of claim 6, wherein the mistrust sentences subcategory comprises at least the second sentence, wherein the second sentence is generated in response to the first sentence.

8. The method of claim 1, wherein the second category is a declarative sentences category, wherein the declarative sentences category comprises a mistrust sentences subcategory and an issue related sentences subcategory.

9. The method of claim 8, wherein the issue related sentences subcategory comprises at least the second sentence, wherein the second sentence is generated in response to the first sentence.

10. The method of claim 1, wherein the TS conversation score is obtained by implementing a multiple linear regression model.

11. The method of claim 1, wherein the TS recommendation comprises an imperative-instruction sentence, wherein the imperative-instruction sentence specifies restarting the user's computing device.

12. A non-transitory computer readable medium comprising computer readable program code, which when executed by a computer processor enables the computer processor to perform a method for managing a technical support (TS) conversation, the method comprising:
determining an initial state of a user based on a TS history of the user;
classifying a first sentence of a TS entity into a first category and a second sentence of the user into a second category;
obtaining, based on the first category and the second category, a mapping between the first sentence and the second sentence;
obtaining a TS conversation score based on the initial state and the second category;
generating a TS recommendation based on the TS history, the mapping, and the TS conversation score; and
initiating display of the TS recommendation on a graphical user interface (GUI) accessible to the TS entity.

13. The non-transitory computer readable medium of claim 12, wherein the first category is an imperative sentences category, wherein the imperative sentences category comprises an instruction sentences subcategory and an advice sentences subcategory.

14. The non-transitory computer readable medium of claim 13, wherein the advice sentences subcategory comprises at least the TS recommendation.

15. The non-transitory computer readable medium of claim 13, wherein the second category is an interrogative sentences category, wherein the interrogative sentences category comprises a mistrust sentences subcategory and an issue related sentences subcategory.

16. The non-transitory computer readable medium of claim 15, wherein the mistrust sentences subcategory comprises at least the second sentence, wherein the second sentence is generated in response to the first sentence.

17. The non-transitory computer readable medium of claim 13, wherein the second category is a declarative sentences category, wherein the declarative sentences category comprises a mistrust sentences subcategory and an issue related sentences subcategory.

18. The non-transitory computer readable medium of claim 17, wherein the issue related sentences subcategory comprises at least the second sentence, wherein the second sentence is generated in response to the first sentence.

19. The non-transitory computer readable medium of claim 13, wherein the TS recommendation comprises an imperative-instruction sentence, wherein the imperative-instruction sentence specifies restarting the user's computing device.

20. A system for managing a technical support (TS) conversation, the system comprising:
a processor comprising circuitry;
memory comprising instructions, which when executed perform a method, the method comprising:
determining an initial state of a user based on a TS history of the user, wherein the initial state of the user specifies an emotional condition of the user, wherein the emotional condition specifies at least one selected from a group consisting of normal, sad, angry, and frustrated;
classifying a first sentence of a TS entity into a first category and a second sentence of the user into a second category;
obtaining, based on the first category and the second category, a mapping between the first sentence and the second sentence;
obtaining a TS conversation score based on the initial state and the second category;
generating a TS recommendation based on the TS history, the mapping, and the TS conversation score, wherein the TS recommendation comprises an imperative-instruction sentence, wherein the imperative-instruction sentence specifies restarting the user's computing device; and
initiating display of the TS recommendation on a graphical user interface (GUI) accessible to the TS entity.
